(19) United States
(12) Patent Application Publication
(10) Pub. No.: US 2025/0088422 A1
(43) Pub. Date: Mar. 13, 2025

(54) NETWORK SETTING VERIFICATION DEVICE, NETWORK SETTING VERIFICATION METHOD, AND RECORDING MEDIUM

(71) Applicant: NEC Corporation, Minato-ku, Tokyo (JP)

(72) Inventor: Shuichi KARINO, Tokyo (JP)

(73) Assignee: NEC Corporation, Minato-ku, Tokyo (JP)

(21) Appl. No.: 18/729,071

(22) PCT Filed: Feb. 7, 2022
(86) PCT No.: PCT/JP2022/004653

§ 371 Date: Jul. 15, 2024

(51) Int. Cl. H04L 41/0866; H04L 41/084; H04L 45/02

(52) U.S. Cl. CPC H04L 41/0866; H04L 41/084; H04L 45/02

(57) ABSTRACT

A network setting verification device according to the present disclosure comprises: an information acquiring means for acquiring route information and setting information held by each network device forming a network; a checking information acquiring means for acquiring checking information used to verify a setting of a checking target, on the basis of the route information and the setting information; a checking means for checking whether the setting of the checking target is appropriate, on the basis of the checking information; and an output means for outputting a result of the check.

### TECHNICAL FIELD

The present disclosure relates to a network setting verification device, a network setting verification method, and a recording medium.

### BACKGROUND ART

There is a technique for verifying whether a setting of a control function of a network device is incomplete.

For example, PTL 1 discloses a technique of comparing design data for a control function of a network device with configuration information acquired from the network device and detecting information that does not match as mismatch data.

### CITATION LIST

### Patent Literature

PTL 1: JP 2016-66945 A

### SUMMARY OF INVENTION

### Technical Problem

However, the above-mentioned invention described in PTL 1 requires design data for the control function of the network device in order to detect mismatch data. Therefore, in the invention described in PTL 1, it takes time and effort to prepare design data for the control function of the network device.

An object of the present disclosure is to provide a network setting verification device that detects an incomplete setting of a network device even without design data.

### Solution to Problem

A network setting verification device according to an aspect of the present disclosure includes an information acquisition means for acquiring route information and setting information held by each of network devices constituting a network, a collation information acquisition means for acquiring collation information used to verify a setting of a collation target based on the route information and the setting information, a collation means for collating whether the setting of the collation target is appropriate based on the collation information, and an output means for outputting a result of the collation.

A network setting verification method according to an aspect of the present disclosure includes acquiring route information and setting information held by each of network devices constituting a network, acquiring collation information used to verify a setting of a collation target based on the route information and the setting information, collating whether the setting of the collation target is appropriate based on the collation information, and outputting a result of the collation.

A recording medium according to an aspect of the present disclosure stores a program for causing a computer to execute acquiring route information and setting information held by each of network devices constituting a network, acquiring collation information used to verify a setting of a collation target based on the route information and the setting information, collating whether the setting of the collation target is appropriate based on the collation information, and outputting a result of the collation.

### Advantageous Effects of Invention

As an example of an effect of the present disclosure, it is possible to provide a network setting verification device that detects an incomplete setting of a network device even without design data.

### BRIEF DESCRIPTION OF DRAWINGS

FIG. 1 is a block diagram illustrating a configuration of a network setting verification device according to a first example embodiment.

FIG. 2 is a diagram illustrating a hardware configuration in which the network setting verification device according to the first example embodiment is implemented by a computer device and its peripheral device.

FIG. 3 is a flowchart illustrating a network setting verification operation according to the first example embodiment.

FIG. 4 is a block diagram illustrating a configuration of a network setting verification device according to a second example embodiment.

FIG. 5 is a diagram for explaining acquisition of collation information according to the second example embodiment.

FIG. 6 is a diagram for explaining acquisition of collation information according to the second example embodiment.

FIG. 7 is an example of a collation result output by an output unit according to the second example embodiment.

FIG. 8 is a flowchart illustrating a network setting verification operation according to the second example embodiment.

FIG. 9 is a diagram illustrating a network setting verification target according to a third example embodiment.

FIG. 10 is a diagram illustrating a network setting verification target according to a fourth example embodiment.

### EXAMPLE EMBODIMENT

Next, example embodiments will be described in detail with reference to the drawings.

### First Example Embodiment

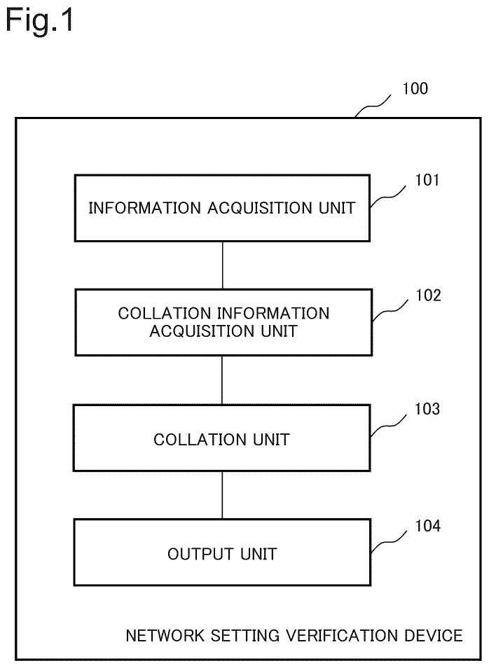

FIG. 1 is a block diagram illustrating a configuration of a network setting verification device 100 according to a first example embodiment. Referring to FIG. 1, the network setting verification device 100 includes an information acquisition unit 101, a collation information acquisition unit 102, a collation unit 103, and an output unit 104. Hereinafter, the network setting verification device 100, which is an essential configuration of the present example embodiment, will be described in detail.

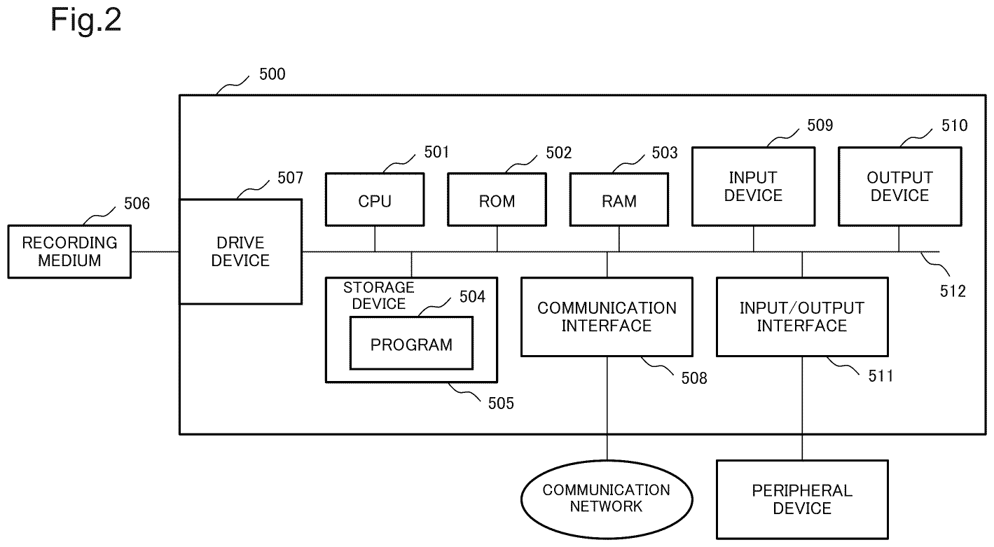

FIG. 2 is a diagram illustrating an example of a hardware configuration in which the network setting verification device 100 according to the first example embodiment of the present disclosure is implemented by a computer device 500 including a processor. As illustrated in FIG. 2, the network setting verification device 100 includes a central processing unit (CPU) 501, memories such as a read only memory (ROM) 502 and a random access memory (RAM) 503, a storage device 505 such as a hard disk that stores a program 504, a communication interface (I/F) 508 for network connection, and an input/output interface 511 that inputs and outputs data. In the first example embodiment, route information and setting information acquired by the information acquisition unit 101 are input to the network setting verification device 100 via the communication I/F 508.

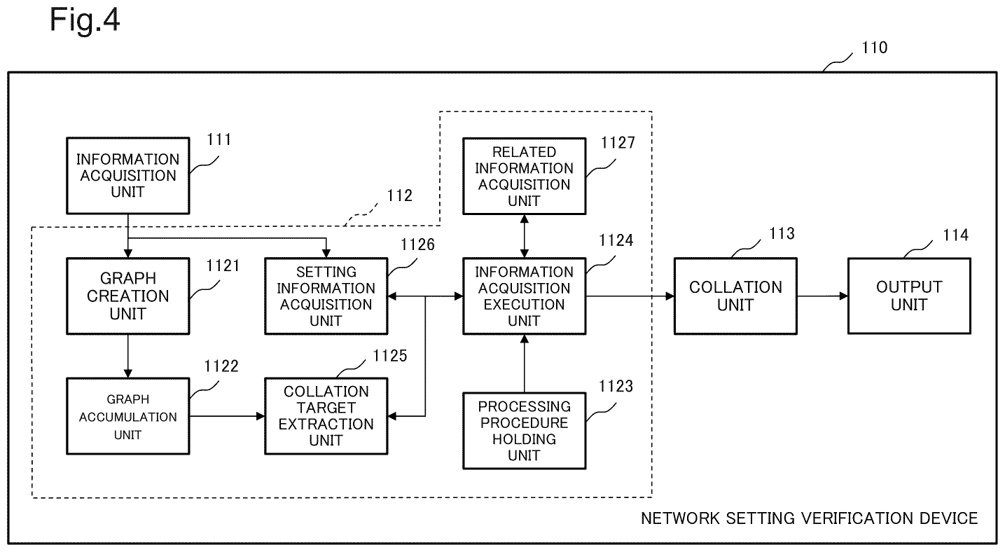

The CPU 501 operates an operating system to control the entire network setting verification device 100 according to the first example embodiment of the present invention. In addition, the CPU 501 reads a program or data from a recording medium 506 mounted on, for example, a drive device 507 to a memory. In addition, the CPU 501 functions as the information acquisition unit 101, the collation information acquisition unit 102, and the collation unit 103, the output unit 104, or some of them in the first example embodiment, and executes a process or a command of a flowchart illustrated in FIG. 4 to be described below based on the program.

The recording medium 506 is, for example, an optical disk, a flexible disk, a magneto-optical disk, an external hard disk, a semiconductor memory, or the like. Some recording media of the storage device are non-volatile storage devices, and programs are recorded therein. In addition, programs may be downloaded from an external computer (not illustrated) connected to a communication network.

The input device 509 is implemented by, for example, a mouse, a keyboard, a built-in key button, or the like, and is used for an input operation. The input device 509 is not limited to the mouse, the keyboard, or the built-in key button, and may be, for example, a touch panel. The output device 510 is implemented by, for example, a display, and is used to confirm an output.

As described above, the first example embodiment illustrated in FIG. 1 is implemented by the computer hardware illustrated in FIG. 2. However, the means for implementing each of the units included in the network setting verification device 100 of FIG. 1 is not limited to the configuration described above. In addition, the network setting verification device 100 may be implemented by one physically coupled device, or may be implemented by two or more physically separated devices by connecting the plurality of devices to each other in a wired or wireless manner. For example, the input device 509 and the output device 510 may be connected to the computer device 500 via a network. In addition, the network setting verification device 100 according to the first example embodiment illustrated in FIG. 1 may be configured by cloud computing or the like.

In FIG. 1, an information acquisition unit 101 is a means for acquiring route information and setting information held by each of network devices constructing a network. The information acquisition unit 101 acquires route information and setting information from an operating network device such as a router, a hub, a gateway, or a switch connected to the network.

Specifically, the information acquisition unit 101 collects route information between adjacent network devices using a link layer discovery protocol (LLDP). In addition, the information acquisition unit 101 may collect route information based on protocols such as a spanning tree protocol (STP), a routing information protocol (RIP), and an open shortest path first (OSPF). When there is a tunnel section configured by a virtual private network VPN, the information acquisition unit 101 also acquires route information of the VPN section.

In addition, the setting information in the present example embodiment is data for controlling a function of each network device, and is set by, for example, a user inputting a command input. The information acquisition unit 101 acquires setting information of each network device from the network device or a management device that manages the network device. The information acquisition unit 101 outputs the route information and setting information acquired as described above to the collation information acquisition unit 102.

The collation information acquisition unit 102 is a means for acquiring collation information used to verify a setting of a collation target based on the route information and the setting information. The collation target includes a network device for which a network setting is to be collated as to whether the network setting is incomplete. The range of the collation target is not limited. The collation information is, for example, a configuration of a network device as a collation target or setting information of a network device as a collation target. The collation information acquisition unit 102 acquires, for example, graph data indicating a connection relationship between nodes based on the route information, the nodes being respective network devices. Then, the collation information acquisition unit 102 extracts a node connection condition or a graph form satisfying a preset condition from the graph data as a collation target. The preset condition is stored in, for example, the storage device 505. The graph form refers to a network connection form. When extracting the collation target, the collation information acquisition unit 102 outputs information on the node as the collation target to the collation unit 103 together with the setting information of the node as the collation target.

The collation information acquisition unit 102 extracts, for example, a configuration including a redundant configuration, a star configuration, a point-to-point configuration, or a network device for which the number of installations is limited as the collation target. The redundant configuration is a configuration including a data transfer route in which a plurality of network devices of the same type are installed. The star configuration is a graph form in which a plurality of network devices are connected to each other via the network setting verification device 100. The point-to-point configuration is a configuration in which two adjacent network devices are connected to each other on a one-to-one basis. The network device for which the number of installations is limited refers to a device that is not normally expected to be installed in a plural number within a single segment such as a dynamic host configuration protocol (DHCP) server. However, the collation target extracted by the collation information acquisition unit 102 is not limited thereto.

The collation unit 103 is a collation means for collating whether the setting of the collation target is appropriate based on the collation information acquired by the collation information acquisition unit 102. The setting being appropriate means a state in which a setting is made to impart a desired function to the network device without incompletion. Specifically, the collation unit 103 collates whether the setting for implementing the function given to the collation target is appropriate based on the collation target and the setting information thereof. The storage device 505 stores, for example, appropriate setting condition information for each collation target. The collation unit 103 determines whether the setting is appropriate by collating the setting with the appropriate setting condition information stored in the storage device 505. The collation unit 103 outputs a collation result to the output unit 104.

The output unit 104 is a means for outputting a result of the collation by the collation unit 103. The output unit 104 outputs the collation result to the output device 510 or the like. The collation result is a result of collating whether the setting of the network device as a collation target is incomplete.

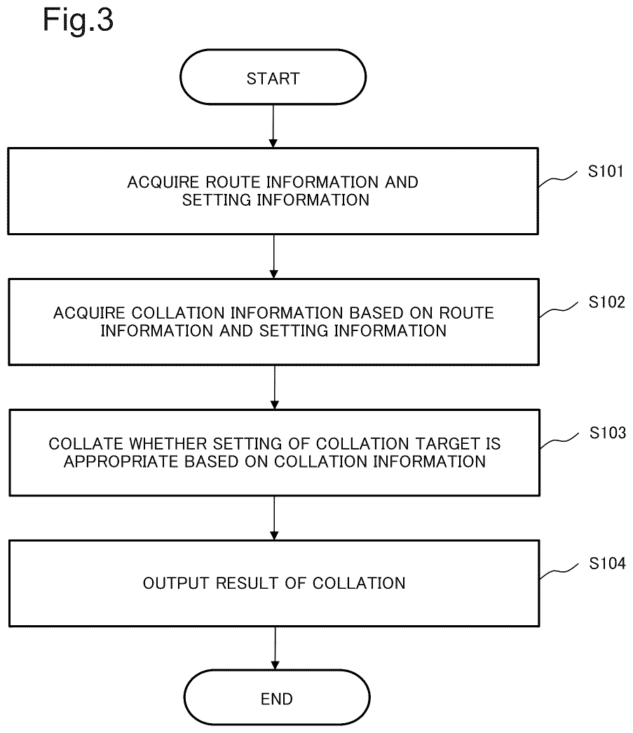

An operation of the network setting verification device 100 configured as described above will be described with reference to a flowchart of FIG. 3.

FIG. 3 is a flowchart illustrating an outline of an operation of the network setting verification device 100 according to the first example embodiment. Note that the process according to this flowchart may be executed based on the program control by the processor described above.

As illustrated in FIG. 3, first, the information acquisition unit 101 acquires route information and setting information held by each of network devices (step S101). Next, the collation information acquisition unit 102 acquires collation information used to verify a setting of a collation target based on the route information and the setting information (step S102). Next, the collation unit 103 collates whether the setting of the collation target is appropriate based on the collation information (step S103). Finally, the output unit 104 outputs a result of the collation by the collation unit 103 (step S104). Then, the network setting verification device 100 ends the network setting verification operation.

In the network setting verification device 100 according to the first example embodiment, the collation unit 103 collates whether the setting of the collation target is appropriate based on the collation information acquired by the collation information acquisition unit 102. As a result, even if there is no design data, it is possible to detect an incomplete setting of a network device.

### Second Example Embodiment

Next, a second example embodiment of the present disclosure will be described in detail with reference to the drawings. Hereinafter, description overlapping with what has been described above will be omitted unless the omission obscures the description of the present example embodiment. The function of each component in each example embodiment of the present disclosure can be implemented not only by hardware similarly to the computer device illustrated in FIG. 2 but also by a computer device based on program control or software. Network setting verification devices 110 according to the second to fifth example embodiments are not different in components, but are different in network configurations as collation targets. In addition, a verification device is not required for each network configuration, but any network configuration can be collated by one device, and the example embodiments can be combined.

In the second example embodiment, the network setting verification device 110 collates a setting of a redundant configuration of a network device that connects a plurality of segments to each other. Specifically, in a case where the collation target is a redundant configuration, the network setting verification device 110 collates whether settings of a plurality of network devices connected to the same plurality of segments exceed a predetermined similarity. The redundant configuration is, for example, a redundant configuration set using a redundancy protocol such as a virtual router redundancy protocol (VRRP), a hot standby router protocol (HSRP), or an extreme standby router protocol (ESRP).

FIG. 4 is a block diagram illustrating a configuration of a network setting verification device 110 according to the second example embodiment of the present disclosure. With reference to FIG. 4, the network setting verification device 100 according to the second example embodiment will be described focused on a difference from the network setting verification device 110 according to the first example embodiment. The network setting verification device 110 according to the second example embodiment includes an information acquisition unit 111, a collation information acquisition unit 112, a collation unit 113, and an output unit 114. The collation information acquisition unit 112 includes a graph creation unit 1121, a graph accumulation unit 1122, a processing procedure holding unit 1123, an information acquisition execution unit 1124, a collation target extraction unit 1125, a setting information acquisition unit 1126, and a related information acquisition unit 1127. Note that a direction of an arrow in FIG. 4 is an example of a data flow between the components, and the present example embodiment is not limited thereto.

The information acquisition unit 111 acquires route information and setting information held by a network device that constructs a network. The information acquisition unit 111 acquires route information and setting information from an operating network device such as a router, a hub, a gateway, or a switch connected to the network. The route information and the setting information are acquired by the information acquisition unit 111 in a similar manner to those in the first example embodiment. When acquiring the route information, the information acquisition unit 111 outputs the route information to the graph creation unit 1121. When acquiring the setting information, the information acquisition unit 111 outputs the setting information to the setting information acquisition unit 1126.

The graph creation unit 1121 creates graph data from the route information. The graph data is information indicating a connection relationship between network devices using nodes and edges on a network. The graph creation unit 1121 accumulates the created graph data in the graph accumulation unit 1122.

The processing procedure holding unit 1123 holds processing procedure information indicating an executing procedure that is a processing procedure for acquiring collation information. The processing procedure holding unit 1123 also holds collation information to be acquired by the collation target extraction unit 1125, the setting information acquisition unit 1126, and the related information acquisition unit 1127 to be described below. In the present example embodiment, a processing procedure without branching is described as an example, but conditional branching or repetition may generally be included.

The information acquisition execution unit 1124 controls each of the collation target extraction unit 1125, the setting information acquisition unit 1126, and the related information acquisition unit 1127 to acquire collation information based on the processing procedure information held by the processing procedure holding unit 1123.

The collation target extraction unit 1125 extracts a node as a collation target based on the graph data accumulated in the graph accumulation unit 1122. The setting information acquisition unit 1126 acquires setting information of the node as the collation target based on the setting information input from the information acquisition unit 111. The setting information is, for example, information on a setting of a function assigned to the node or information on a segment connected to the node.

The related information acquisition unit 1127 acquires related information related to the setting information. The related information is information necessary for collating whether the setting of the function assigned to the collation target is incomplete. In addition, the information acquisition execution unit 1124 outputs the collation information acquired by the collation target extraction unit 1125, the setting information acquisition unit 1126, and the related information acquisition unit 1127 to the collation unit 123.

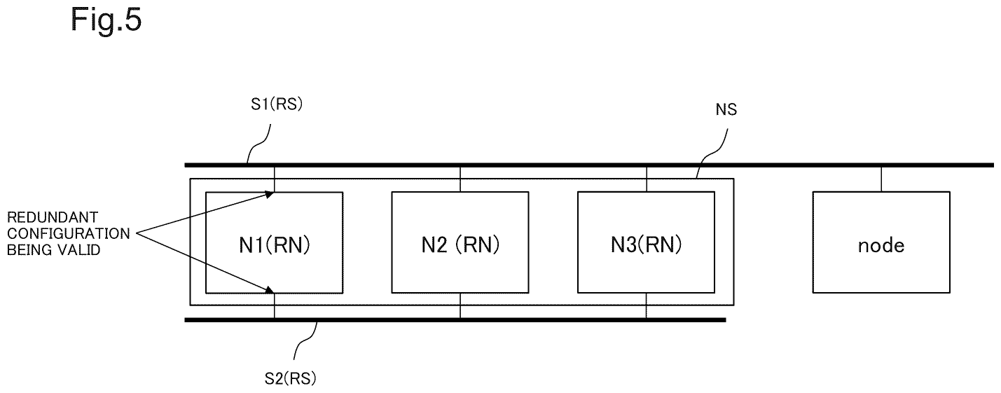

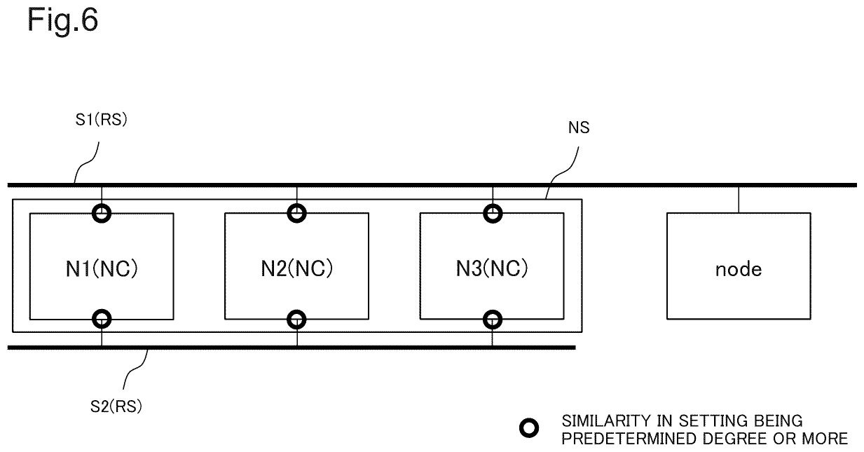

Here, a specific example of a method in which the collation target extraction unit 1125, the setting information acquisition unit 1126, and the related information acquisition unit 1127 acquire collation information will be described with reference to the drawings. FIGS. 5 and 6 are diagrams for explaining acquisition of collation information in the second example embodiment. In the examples of FIGS. 5 and 6, three nodes (N1, N2, N3) are connected to two segments (S1, S2).

The collation target extraction unit 1125, the setting information acquisition unit 1126, and the related information acquisition unit 1127 execute a processing procedure for acquiring collation information based on the processing procedure information held by the processing procedure holding unit 1123. That is, when there are two or more nodes N1, . . . , and Nm connected to all of a plurality of segments S1, . . . , and Sn in the graph data, the collation target extraction unit 1125 extracts them as collation targets and sets them as NS. In the example of FIG. 5, there are two segments (S1, S2), and the collation target extraction unit 1125 extracts three nodes (N1, N2, N3) connected to these segments, and sets them as NS. Then, the collation target extraction unit 1125 extracts all sets NS1, . . . , and NSp of NS, and sets them as NSS. However, the example of NS (NSS) extracted by the collation target extraction unit 1125 is not limited thereto, and the number of segments may be three or more, or the number of nodes may be two.

The setting information acquisition unit 1126 extracts segments connected to a node with a valid redundant configuration from among setting data of any of the nodes RN (N1, N2, N3), which are elements of the NSS, as setting information, and sets the extracted segments as RS. In the example of FIG. 5, when the setting information of the redundant configuration of the node N1 is valid, the setting information acquisition unit 1126 extracts the segments S1 and S2 connected to the node N1. Then, the setting information acquisition unit 1126 extracts all set segments RSI, . . . , and RSr of RS as RSS. The redundant configuration being valid means that, for example, a command necessary for taking the redundant configuration is set. For example, in a case where the redundant configuration is an HSRP, no switchport and standby are set.

The related information acquisition unit 1127 extracts nodes between which a similarity in setting data exceeds a predetermined value from a set of nodes connected to the segment RS, which is each element of RSS, and sets the extracted nodes as NC. In the example of FIG. 6, the related information acquisition unit 1127 extracts N1, N2, and N3 as nodes between which the setting data similarity exceeds the predetermined value from the set NS of nodes connected to the segments S1 and S2. The similarity in setting data can be calculated using any known method. For example, the similarity may be calculated by comparing character strings of commands. Then, the related information acquisition unit 1127 extracts all sets NC1, . . . , and NCs of NC, and set them as NCS.

The information acquisition execution unit 1124 outputs the collation information acquired as described above to the collation unit 113. In the present example embodiment, the collation information includes NSS, RSS, and NCS, but in order to simplify the description, NSS, RSS, and NCS will be described below as NS, RS, and NC, respectively.

The collation unit 113 is a means for collating whether the settings of the network devices, which are nodes as collation targets, are appropriate based on the collation information input from the information acquisition execution unit 1124. In the present example embodiment, first, the collation unit 113 specifies collation targets, and estimates that a redundancy function is applied to the collation targets based on the setting information of the specified collation targets. Next, the collation unit 113 determines, based on the related information, whether settings have been appropriately made to impart a redundancy function to the collation targets. The settings being appropriate means that the network devices N1, N2, and N3 (NC) connected to the same segments S1 (RS) and S2 (RS) as NS are appropriately set to have a redundant configuration with no switchport and standby or the like. Conditions for appropriate settings are stored in, for example, the storage device 505. When the network devices N1, N2, and N3 are set to have a redundant configuration, the collation unit 113 determines that the settings are appropriate. On the other hand, when any of the network devices N1, N2, and N3 is not set to have a redundant configuration, the collation unit 113 determines that the settings are not appropriate.

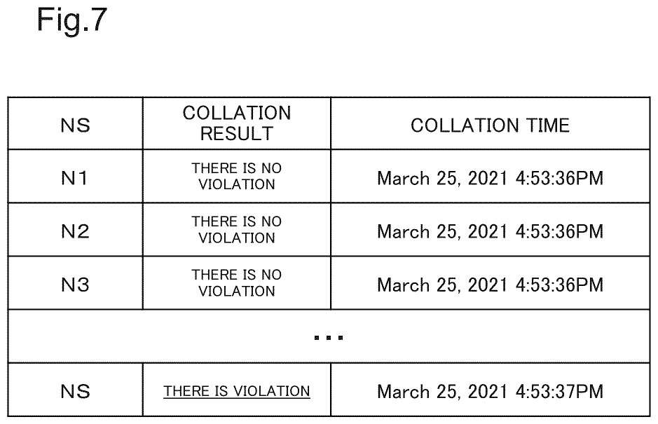

The output unit 114 outputs a result of the collation by the collation unit 113. FIG. 7 is a diagram illustrating an example of an output by the output unit according to the second example embodiment. As illustrated in FIG. 7, a collation result and a collation time for each network device NC are illustrated. In the example of FIG. 7, the output unit 104 outputs that there is no violation when the settings are not incomplete. On the other hand, when the settings are incomplete, the output unit 104 outputs that there is a violation. When the collation result indicates that there is a violation, the output unit 114 may display a detailed screen of the setting information, for example, with a character indicating that there is a violation may be a hyperlink.

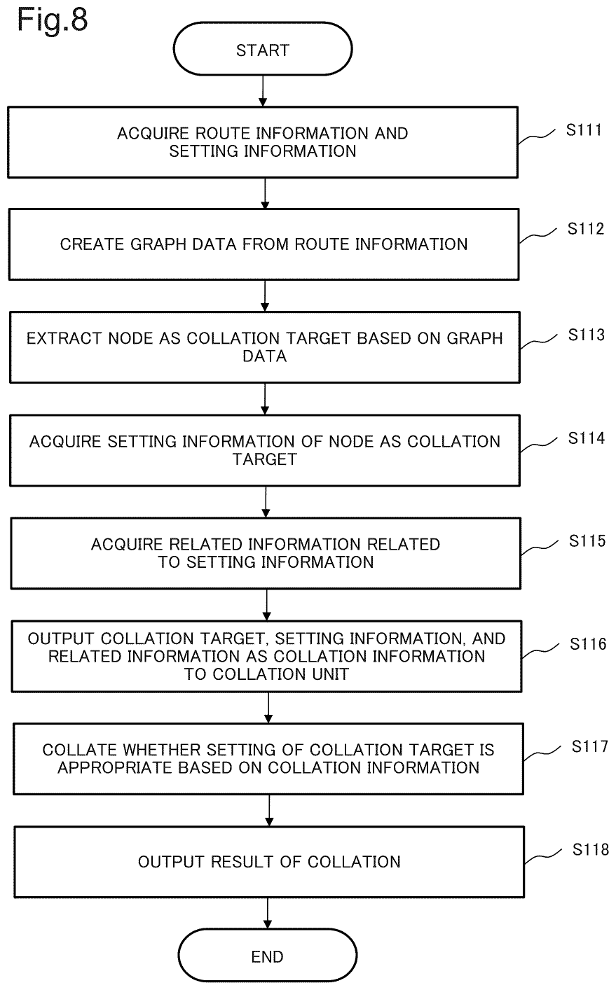

An operation of the network setting verification device 110 configured as described above will be described with reference to a flowchart of FIG. 8.

FIG. 8 is a flowchart illustrating an outline of an operation of the network setting verification device 110 according to the second example embodiment. Note that the process according to this flowchart may be executed based on the program control by the processor described above.

As illustrated in FIG. 8, first, the information acquisition unit 111 acquires route information and setting information held by each of network devices (step S111). Next, the graph creation unit 1121 creates graph data from the route information (step S112). Next, the collation target extraction unit 1125 extracts a node as a collation target based on the graph data accumulated in the graph accumulation unit 1122 (step S113). Next, the setting information acquisition unit 1126 acquires information on a segment connected to the node as setting information of the node as the collation target (step S114). The related information acquisition unit 1127 extracts related information related to the setting information (step S115). Next, the information acquisition execution unit 1124 outputs the collation target, the setting information, and the related information to the collation unit 113 as collation information (step S116). The collation unit 113 collates whether the setting of the collation target is appropriate based on the collation information (step S117). Finally, the output unit 114 outputs a result of the collation by the collation unit 113 (step S118). Then, the network setting verification device 110 ends the network setting verification operation.

In the network setting verification device 110 according to the second example embodiment of the present disclosure, the collation unit 113 collates whether the setting of the collation target is appropriate based on the collation target, the setting information, and the related information as the collation information. As a result, the incomplete setting of the collation target can be verified in more detail.

### Third Example Embodiment

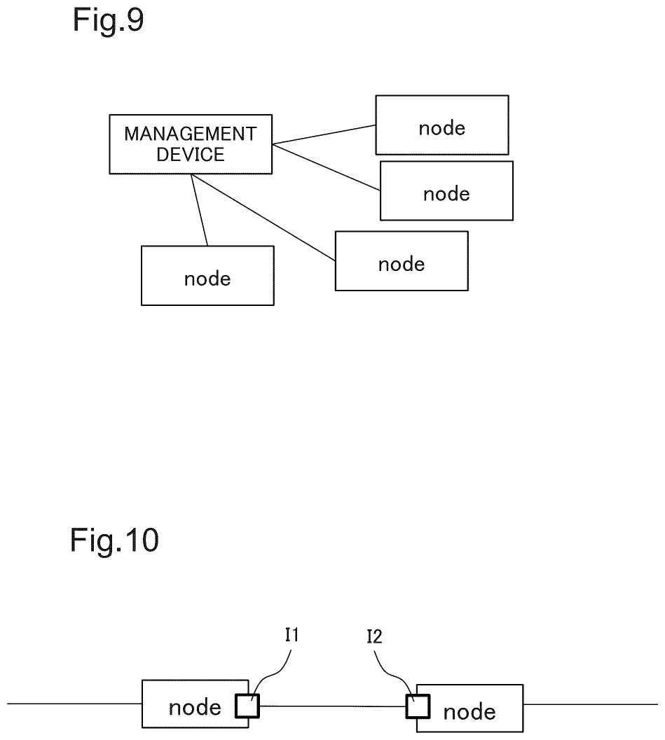

Next, a third example embodiment of the present disclosure will be described. Hereinafter, description overlapping with what has been described above will be omitted unless the omission obscures the description of the present example embodiment. FIG. 9 is a diagram illustrating a network setting verification target according to the third example embodiment. In the third example embodiment, when a management device and network devices to be managed form a star-type graph form, the network setting verification device 110 collates whether a privileged access setting of each of the network devices to be managed is appropriate. In the present example embodiment, the network setting verification device 110 may be configured as a management device. In addition, a network device such as a log management device and an operation monitoring device may be configured as the management device. In the present example embodiment, it is assumed that the management device is authorized to hold or output setting information of a plurality of network devices. Note that the collation target in the present example embodiment includes not only a case where a star-type graph appears on the network topology but also a configuration in which a plurality of independent network devices are connected to one management device.

In the present example embodiment, the processing procedure holding unit 1123 holds the following information as the processing procedure information. (1) Each network device to be managed is set as a node from graph data, and setting information Cl, . . . , and Cn of the respective nodes are acquired and set as CS. (2) Authentication information A1, . . . , and An are acquired from the respective nodes of CS, are set as AS, which is set as collation information. The collation target extraction unit 1125 and the setting information acquisition unit 1126 acquire collation information based on the processing procedure information. That is, the collation target extraction unit 1125 extracts a node group constituting a star-type graph form as a collation target from the graph data accumulated in the graph accumulation unit 1122. The setting information acquisition unit 1126 acquires setting information CS of each node as the collation target based on the setting information input from the information acquisition unit 111. Next, the setting information acquisition unit 1126 acquires authentication information AS of each node as the collation target. The authentication information in the present example embodiment is information regarding an access right of each node, and includes, for example, an identifier such as a serial number of the node, a log-in means list, authentication information for each log-in means, privilege acquisition means, or authentication information for each privilege acquisition means. In addition, the authentication information includes, for example, whether a password for login or privilege acquisition is set.

The related information acquisition unit 1127 acquires information on management of a function or an access history for each node. The information acquisition execution unit 1124 outputs the collation information acquired by the collation target extraction unit 1125, the setting information acquisition unit 1126, and the related information acquisition unit 1127 to the collation unit 123. However, in the third example embodiment, the related information acquisition unit 1127 is not an essential component.

The collation unit 123 collates whether the settings of the network devices, which are nodes as collation targets, are appropriate based on the collation information input from the information acquisition execution unit 1124. In the present example embodiment, the settings being appropriate means that the information regarding the access right matches between network devices. The setting information when the settings are appropriate is stored in, for example, the storage device 505. When there is a difference in log-in means or there is an access route in which a password is not set between the nodes, the collation unit 123 determines that the settings of the nodes are not appropriate.

### Fourth Example Embodiment

First, a fourth example embodiment of the present disclosure will be described. Hereinafter, description overlapping with what has been described above will be omitted unless the omission obscures the description of the present example embodiment. FIG. 10 is a diagram illustrating a network setting verification target according to the fourth example embodiment. In the fourth example embodiment, when the network configuration is a point-to-point configuration, the network setting verification device 110 collates whether settings related to line speeds of interfaces of nodes facing each other are appropriate. The point-to-point configuration in the present example embodiment also includes a point-to-point configuration between nodes that are remote bases connected to each other by a VPN.

The processing procedure holding unit 1123 holds the following information as the processing procedure information. (1) Edges V1, . . . , and Vn are extracted from the graph data, and a set of nodes (N1, M1), . . . , and (Nn, Mn) at both end points of the edges are further extracted. (2) For each set of nodes Ni and Mi, setting information CNi and CMi of interfaces corresponding to the edge Vi is acquired. (3) Setting items CNSi and CMSi of line speeds are acquired from CNi and CMi, respectively, and are set as collation information. The collation target extraction unit 1125 and the setting information acquisition unit 1126 acquire collation information based on the processing procedure information held in the processing procedure holding unit 1123. That is, the collation target extraction unit 1125 extracts the above-described node groups (N1, M1), . . . , and (Nn, Mn) as collation targets from the graph data accumulated in the graph accumulation unit 1122. The collation target extraction unit 1125 extracts these node groups, for example, by using an LLDP. The setting information acquisition unit 1126 acquires setting information (CNi, CMi) of nodes as collation targets based on the setting information input from the information acquisition unit 111. Next, the setting information acquisition unit 1126 acquires line speeds (CNSi, CMSi) of interfaces I1 and I2 of the nodes as the collation targets. The line speeds are output by inputting a command such as show interface status.

The information acquisition execution unit 1124 outputs the collation information acquired by the collation target extraction unit 1125 and the setting information acquisition unit 1126 to the collation unit 123.

The collation unit 123 collates whether the settings of the network devices, which are nodes as collation targets, are appropriate based on the collation information input from the information acquisition execution unit 1124. In the present example embodiment, the settings being appropriate means a case where the pieces of information on the line speeds of the interfaces facing each other match or at least one of the interfaces is automatically set (auto). Conditions for appropriate settings are stored in, for example, the storage device 505. When the pieces of information on the line speeds of the interfaces facing each other match or one of the interfaces is automatically set, the collation unit 123 determines that the settings of the nodes are appropriate. On the other hand, the pieces of information on the line speeds of the interfaces facing each other do not match or one of the interfaces is not automatically set, the collation unit 123 determines that the settings of the nodes are inappropriate. Note that, as an example of a setting other than the line speed, the network setting verification device 110 may determine whether the setting of the network device is appropriate when the pieces of setting information for full-duplex/half-duplex communication of the interfaces of the nodes facing each other match.

### Fifth Example Embodiment

First, a fifth example embodiment of the present disclosure will be described. Hereinafter, description overlapping with what has been described above will be omitted unless the omission obscures the description of the present example embodiment. In the fifth example embodiment, when a network device is limited in the number of installations, the network setting verification device 110 collates whether the number of installations is appropriate. In the present example embodiment, a DHCP server is taken as an example of a network device that is limited in the number of installations.

The collation target extraction unit 1125 extracts a node in which the function of the DHCP server is set as the collation target from the graph data accumulated in the graph accumulation unit 1122. The function setting of the DHCP server may be, for example, a setting made by inputting a command such as service dhcp. The setting information acquisition unit 1126 acquires setting information of the node as the collation target based on the setting information input from the information acquisition unit 111. The setting information in the present example embodiment is information on a segment to which an interface set as the DHCP server is connected.

The related information acquisition unit 1127 acquires information on whether there is a node in which the function of the DHCP server is set from among a set of nodes connected to the segment. The information acquisition execution unit 1124 outputs the collation information acquired by the collation target extraction unit 1125, the setting information acquisition unit 1126, and the related information acquisition unit 1127 to the collation unit 123.

The collation unit 123 collates whether the settings of the nodes as collation targets are appropriate based on the collation information input from the information acquisition execution unit 1124. In the present example embodiment, the settings being appropriate means that there is no plurality of network devices in which the function of the DHCP server is set on the same segment. The setting information when the settings are appropriate is stored in, for example, the storage device 505. When there is only one network device in which the function of the DHCP server is set, the collation unit 123 determines that the settings of the network devices are appropriate. When there is a plurality of network devices in which the function of the DHCP server is set, the collation unit 123 determines that the settings of the nodes are not appropriate.

Another example of a network device that is limited in the number of installations according to the fifth example embodiment is a network device having the same priority in a redundant configuration using a VRRP. The priority of the VRRP is a value for determining which network device is currently in use in a redundant configuration. Therefore, in the redundant configuration using the VRRP, it is not an appropriate setting that there are a plurality of network devices having the same priority value. In this case as well, as described above, the collation target extraction unit 1125 extracts nodes as collation targets, and the setting information acquisition unit 1126 acquires setting information (priorities) of the nodes as the collation targets. In addition, the related information acquisition unit 1127 acquires information on whether there are network devices having the same priority value in the redundant configuration using the VRRP. Next, the collation unit 123 collates whether the settings of the network devices as collation targets are appropriate based on the acquired collation information. That is, when there are no plurality of network devices having the same priority value in the redundant configuration using the VRRP, the collation unit 123 determines that the settings of the network devices are appropriate. On the other hand, when there are a plurality of network devices having the same priority value in the redundant configuration using the VRRP, the collation unit 123 determines that the settings of the network devices are not appropriate.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

For example, although a plurality of operations are described in order in the form of a flowchart, the order in which the operations are described does not limit an order in which the plurality of operations are executed. Therefore, when each example embodiment is implemented, the order in which the plurality of operations are executed can be changed if the content is not affected by the change. In the second to fifth example embodiments, the information acquisition execution unit 1124 outputs the collation information acquired by the collation target extraction unit 1125, the setting information acquisition unit 1126, and the related information acquisition unit 1127 to the collation unit 123, but the present invention is not limited thereto. Each of the collation target extraction unit 1125, the setting information acquisition unit 1126, and the related information acquisition unit 1127 may output information acquired by itself to the collation unit 123.

### REFERENCE SIGNS LIST

100, 110 Network setting verification device
101, 111 Information acquisition unit
102, 112 Collation information acquisition unit
103, 113 Collation unit
104, 114 Output unit
1121 Graph creation unit
1122 Graph accumulation unit
1123 Processing procedure holding unit
1124 Information acquisition execution unit
1125 Collation target extraction unit
1126 Setting information acquisition unit
1127 Related information acquisition unit

What is claimed is:

1. A network setting verification device comprising:
a memory storing instructions; and
at least one processor configured to execute the instructions to:
acquire route information and setting information held by each of network devices constituting a network;
acquire collation information used to verify a setting of a collation target based on the route information and the setting information;
collate whether the setting of the collation target is appropriate based on the collation information; and
output a result of the collation.

2. The network setting verification device according to claim 1, wherein
collate whether the setting of the collation target is for implementing a function given to the collation target based on the collation target and the setting of the collation target.

3. The network setting verification device according to claim 1, wherein
the collation target is identified by a condition for connection between nodes or a graph form, the nodes representing the respective network devices.

4. The network setting verification device according to claim 3, wherein
the collation target includes one of a redundant configuration, a star configuration, a point-to-point configuration, and a configuration including a network device that is limited in the number of installations.

5. The network setting verification device according to claim 4, wherein the at least one processor is further configured to execute the instructions to:
in a case where the collation target is the redundant configuration,
collate whether the setting for a plurality of network devices connected to the same plurality of segments exceeds a predetermined similarity.

6. The network setting verification device according to claim 4, wherein the at least one processor is further configured to execute the instructions to:
in a case where the collation target is a star configuration,
collate whether the setting for a privileged access of each network device other than a management device is appropriate.

7. The network setting verification device according to claim 4, wherein the at least one processor is further configured to execute the instructions to:
in a case where the collation target is a point-to-point configuration,
collate whether the setting related to line speeds of interfaces of network devices facing each other is appropriate.

8. The network setting verification device according to claim 4, wherein the at least one processor is further configured to execute the instructions to:
in a case where the collation target includes a network device that is limited in the number of installations,
collate whether the number of installations is appropriate.

9. A network setting verification method comprising:
acquiring route information and setting information held by each of network devices constituting a network;
acquiring collation information used to verify a setting of a collation target based on the route information and the setting information;
collating whether the setting of the collation target is appropriate based on the collation information; and
outputting a result of the collation.

10. A non-transitory recording medium storing a program for causing a computer to execute:
acquiring route information and setting information held by each of network devices constituting a network;
acquiring collation information used to verify a setting of a collation target based on the route information and the setting information;
collating whether the setting of the collation target is appropriate based on the collation information; and
outputting a result of the collation.
